(19) United States
(12) Patent Application Publication
(10) Pub. No.: US 2019/0162274 A1
(43) Pub. Date: May 30, 2019

(54) Gear Mechanism for a Motor Vehicle

(71) Applicant: ZF Friedrichshafen AG, Friedrichshafen (DE)

(72) Inventors: Stefan Beck, Eriskirch (DE); Marc Seeberger, Oberteuringen (DE); Michael Wechs, Weißensberg (DE); Wolfgang Rieger, Friedrichshafen (DE)

(21) Appl. No.: 16/098,295

(22) PCT Filed: Mar. 27, 2017
(86) PCT No.: PCT/EP2017/057145

§ 371 Date: Nov. 1, 2018

(30) Foreign Application Priority Data
May 2, 2016 (DE) 10 2016 207 480.6

(51) Int. Cl. F16H 3/66

(52) U.S. Cl. CPC F16H 3/66; F16H 2200/0043; F16H 2200/2007; F16H 2200/2094; F16H 2200/2064; F16H 2200/2097; F16H 2200/2038

(57) ABSTRACT

A transmission for a motor vehicle having a first, a second, a third, a fourth, and a fifth shift element that are selectively actuated to couple a first and a second planetary gear set to each other while selecting different gears between an input shaft and an output shaft. The input shaft is rotationally fixable to a first element of the second planetary gear set via the first shift element and to a second element of the second planetary gear set via the second shift element. The first element of the second planetary gear set is rotationally fixable to a rotationally fixed component via the third shift element, and the second element of the second planetary gear set is rotationally fixable to the rotationally fixed component via the fourth shift element. Additionally, a third element of the second planetary gear set is rotationally fixed to the output shaft.

### FIELD OF THE INVENTION

The invention relates generally to a transmission for a motor vehicle, and to a motor vehicle drive train including such a transmission.

### BACKGROUND

DE 10 2013 002 586 A1 describes a transmission for a motor vehicle, in which two planetary gear sets are provided between an input shaft and an output shaft, each of is the two planetary gear sets being composed of one sun gear, one ring gear, and one planet carrier. Furthermore, multiple shift elements are provided, the selective actuation of which couples the planetary gear sets to each other in order to define different gears between the input shaft and the output shaft. In all, four forward gears are selectable between the input shaft and the output shaft in this case.

### SUMMARY OF THE INVENTION

In the present case, a transmission refers to a multi-stage transmission, i.e., multiple different transmission ratios are selectable, as gears, between an input end and an output end of the transmission by actuating appropriate shift elements, wherein this is preferably automatically carried out. Depending on the arrangement of the shift elements, the shift elements are clutches or even brakes. These types of transmissions are utilized preponderantly in motor vehicles in order to implement an available tractive force of a drive machine of the particular motor vehicle in a manner which is suitable with respect to various criteria.

An example problem addressed by the present invention is that of providing an alternative embodiment of the transmission known in the prior art, that includes four forward gears between an input shaft and an output shaft.

According to example aspects of the invention, a transmission includes an input shaft and an output shaft, as well as a first planetary gear set and a second planetary gear set. The first and second planetary gear sets each include a first element, a second element, and a third element in the form of a sun gear, a planet carrier, and a ring gear, wherein the first and second planetary gear sets guide a power flow from the input shaft to the output shaft. For this purpose, a first shift element, a second shift element, a third shift element, a fourth shift element, and a fifth shift element are provided, the selective actuation of the shift elements couples the planetary gear sets to each other while selecting different gears between the input shaft and the output shaft.

In this case, the input shaft is rotationally fixable to the first element of the second planetary gear set via the first shift element and to the second element of the second planetary gear set via the second shift element, wherein the first element of the second planetary gear set is rotationally fixable to a rotationally fixed component of the transmission via the third shift element. The second element of the second planetary gear set is also rotationally fixable to the rotationally fixed component via the fourth shift element. Moreover, the third element of the second planetary gear set is rotationally fixed to the output shaft.

In other words, the third element of the second planetary gear set is therefore permanently rotationally fixed to the output shaft. By engaging the first shift element, the input shaft of the transmission is rotationally fixed to the first element of the second planetary gear set, whereas an actuation of the second shift element results in a rotationally fixed connection of the input shaft to the second element of the second planetary gear set. Moreover, an engagement of the third shift element results in a fixation of the first element of the second planetary gear set to the rotationally fixed component, whereby the second element of the second planetary gear set is also coupled in a rotationally fixed manner upon actuation of the fourth shift element.

A transmission according to the invention is distinguished by a compact design, low component loads, and good gearing efficiency.

According to one embodiment of the invention, the first element of the first planetary gear set is rotationally fixed to the first element of the second planetary gear set, the third element of the second planetary gear set is also rotationally fixed to the second element of the first planetary gear set. In addition, the third element of the first planetary gear set is rotationally fixable to the rotationally fixed component via the fifth shift element. The second element of the first planetary gear set and the third element of the second planetary gear set are therefore jointly rotationally fixed to the output shaft in this case. Each of the first and the second shift elements is a clutch in this case, which, upon actuation, equalize rotatable components of the transmission to each other in terms of their turning motions, while each of the third, the fourth, and the fifth shift elements is a brake which, upon actuation, decelerate the respective rotatable component of the transmission to a standstill and rotationally fix it to the rotationally fixed component.

According to one alternative embodiment of the invention, the third element of the first planetary gear set is permanently rotationally fixed to the rotationally fixed component, whereas the second element of the first planetary gear set is connected to the third element of the second planetary gear set. Moreover, the first element of the first planetary gear set is rotationally fixable to the first element of the second planetary gear set via the fifth shift element. In this case as well, the second element of the first planetary gear set and the third element of the second planetary gear set are jointly rotationally fixed to the output shaft. Furthermore, each of the first, the second, and the fifth shift elements is a clutch which, upon actuation, equalizes rotatable components of the transmission to each other in terms of their turning motions. On the other hand, each of the third and the fourth shift elements is implemented as a brake which, upon actuation, decelerates the respective rotatable component of the transmission to a standstill and rotationally fixes it to the rotationally fixed component.

Further alternatively to the two aforementioned variants, the third element of the first planetary gear set is permanently rotationally fixed to the rotationally fixed component and the first element of the first planetary gear set is rotationally fixed to the first element of the second planetary gear set, while the second element of the first planetary gear set is rotationally fixable to the third element of the second planetary gear set and, therefore, also to the output shaft, via the fifth shift element. In this case as well, each of the first, the second, and the fifth shift elements is a clutch which, upon actuation, equalize rotatable components of the transmission to each other in terms of their turning motions, while each of the third and the fourth shift elements is a brake which, upon actuation, decelerates the respective rotatable component of the transmission to a standstill and rotationally fixes it to the rotationally fixed component.

In the aforementioned variants of a transmission according to the invention, four forward gears as well as one reverse gear are implementable in each case. In doing so, a first forward gear is selected by actuating the first and the fifth shift elements, while a second forward gear is selected by engaging the second and the fifth shift elements. Moreover, a third forward gear is selected by actuating the first and the second shift elements, while a fourth forward gear is selected by actuating the second and the third shift elements. On the other hand, the reverse gear is selected by actuating the first and the fourth shift elements.

With the aid of a suitable selection of stationary transmission ratios of the planetary gear sets, a transmission ratio range which is suitable for the application in the case of a motor vehicle is implemented as a result. The condition of two shift elements in each case is always to be varied in order to successively select the forward gears in sequence, by disengaging one of the shift elements contributing to the preceding forward gear and engaging another shift element in order to implement the subsequent forward gear. As a further consequence thereof, a shift between the gears can take place very rapidly.

Advantageously, in the transmission according to the invention, one reverse gear for a power train is implementable via the drive machine connected upstream from the transmission. This reverse gear is implementable, in this case, as an alternative or in addition to an arrangement of an electric machine in the transmission, in order to still be capable of enabling the motor vehicle to travel in reverse in the case of a failure of the electric machine.

According to yet another embodiment of the invention, either or both of the first and second planetary gear sets may be a minus planetary gear set, wherein the first element of the respective planetary gear set is a sun gear, the second element of the respective planetary gear set is a planet carrier, and the third element of the respective planetary gear set is a ring gear. A minus planetary gear set is known to a person skilled in the art as having a sun gear, a planet carrier, and a ring gear, wherein the planet carrier guides at least one planetary gear, although preferably multiple planetary gears with each intermeshing with the sun gear as well as with the surrounding ring gear. Of the first and the second planetary gear sets, one or both planetary gear sets are configured as such minus planetary gear sets. It is particularly preferred when each of the first and second planetary gear sets is a minus planetary gear set, whereby a particularly compact design is implemented.

Alternatively or additionally thereto, either or both of the first and second planetary gear sets may be a plus planetary gear set, wherein the first element of the respective planetary gear set is a sun gear, the second element of the respective planetary gear set is a ring gear, and the third element of the respective planetary gear set is a planet carrier. In a plus planetary gear set as well, a sun gear, a ring gear, and a planet carrier are present, wherein the latter guides at least one pair of planet gears, in which one planet gear of each pair of the at least one pair of planet gears is meshed with the internal sun gear and the other planet gear of each pair of the at least one pair of planet gears is meshed with the surrounding ring gear, and the planet gears in each pair of the at least one pair of planet gears are intermeshed with each other. In the transmission according to the invention, one or both of the first and second planetary gear sets is a plus planetary gear set, provided this is permissible by the connection of the individual elements.

Where possible, a minus planetary gear set is replaceable by a plus planetary gear set, wherein, as compared to the minus planetary gear set, the ring gear connection and the planet carrier connection are to be interchanged, and a respective stationary transmission ratio is to be increased by one. As mentioned above, it is preferred, however, when both of the first and second planetary gear sets are minus planetary gear sets.

In one refinement of the invention, one or multiple shift elements are each implemented as a friction-locking shift element. Friction-locking shift elements have the advantage that they are also shiftable under load, and therefore a changeover between the gears is carried out without an interruption of tractive force. It is particularly preferred, however, when each of the fourth shift element and/or the fifth shift element is a form-fit shift element, such as a dog clutch or a lock-synchronizer mechanism. This is the case because the fifth shift element contributes to the first two forward gears, and therefore, when the gears are upshifted in succession, all that is necessary in this case is to disengage the fifth shift element. The fourth shift element contributes only to the engagement of the reverse gear. A form-fit shift element has the advantage over a friction-locking shift element that only low drag torques occur in the disengaged condition, and therefore high efficiency is achievable. In addition, a version as a steel-steel element or a band brake is also an option here.

According to one design option of the invention, the first and/or the third shift elements are/is arranged on a side of the first planetary gear set facing a mounting interface of the input shaft. The two shift elements therefore lie on an input side of the transmission and are easily accessed. Alternatively or additionally, the second shift element and/or the fourth shift element are arranged on a side of the second planetary gear set facing away from a mounting interface of the input shaft. Consequently, the second shift element and the fourth shift element are also easily accessed from an axial side of the transmission. Depending on the variant of the transmission according to the invention, the fifth shift element radially surrounds the first planetary gear set and lies axially at the level thereof or on the input side thereof or axially between the planetary gear sets.

According to yet another embodiment of the invention, mounting interfaces of the input shaft and of the output shaft are situated coaxially to each other. In this case, the mounting interface of the input shaft is preferably provided at one axial end of the transmission, while the mounting interface of the output shaft is located either axially between the first planetary gear set and the third shift element or axially between the first and the second planetary gear sets. In particular, the external interface of the output shaft includes a tooth system in this case, which intermeshes with a tooth system of a shaft arranged axially parallel to the input shaft axis of the transmission. It is particularly preferred when the axle differential of a drive axle is then arranged on this shaft. This type of arrangement is particularly suitable for the application in a motor vehicle including a drive train aligned transversely to the direction of travel of the motor vehicle.

In one refinement of the invention, an electric machine is provided, a rotor of the electric machine being coupled in a rotationally fixed manner to one of the rotatable components of the transmission. Preferably, a stator of the electric machine is then rotationally fixed to the rotationally fixed component of the transmission, wherein the electric machine is operable as an electric motor and/or as a generator in this case in order to implement different functions. In particular, purely electric driving, boosting via the electric machine, deceleration and recuperation, and/or synchronization in the transmission are implementable via the electric machine in this case. The rotor of the electric machine can lie coaxial to the respective component or axially offset with respect thereto in this case, wherein, in the latter case, a coupling via an intermediate spur gear stage or even a flexible traction drive mechanism is then implementable.

Preferably, the rotor of the electric machine is coupled in a rotationally fixed manner to the input shaft in this case, wherein, as a result, purely electric travel of the motor vehicle is implemented in a suitable way. For this purpose, one of the gears in the transmission is selected, wherein, in the forward gears, one reverse gear of the motor vehicle is also implementable in this case, by initiating a turning motion in the opposite direction via the electric machine, whereby the reverse operation of the motor vehicle takes place in the transmission ratio of the respective forward gear. Consequently, the transmission ratios of the forward gears are usable for electric forward travel as well as for electric travel in reverse. The rotor of the electric machine, apart from the input shaft, is also connectable to one of the remaining rotatable components, however.

According to yet another design option of the invention, which is implemented, in particular, in combination with the aforementioned arrangement of an electric machine, a separating clutch is also provided, via which the input shaft is connectable in a rotationally fixed manner to a connecting shaft. The connecting shaft is utilized within a motor vehicle drive train as the connection to the drive machine. Providing the separating clutch has the advantage, in this case, that a connection to the driving machine is interruptible during the purely electric driving, whereby the drive machine is not entrained. The separating clutch is preferably, in this case, a friction-locking shift element, such as a multi-disk clutch, although the separating clutch can alternatively be present a form-fit shift element, such as a dog clutch or a lock-synchronizer mechanism.

In general, a starting component is connectable upstream from the transmission, for example a hydrodynamic torque converter or a friction clutch. This starting component is then also an integral part of the transmission and acts to configure a starting process, in that the starting component enables a slip speed between the internal combustion engine and the input shaft of the transmission. In this case, one of the shift elements of the transmission or the separating clutch, which may be present, is also such a starting component, in that it is a frictional shift element. In addition, a one-way clutch with respect to the transmission housing or to another shaft is positionable on each shaft of the transmission, in principle.

The transmission according to the invention is, in particular, part of a motor vehicle drive train and is then arranged between a drive machine of the motor vehicle, which is configured, in particular, as an internal combustion engine, and further components of the drive train, which follow in the direction of power flow to driving wheels of the motor vehicle. In this case, the input shaft of the transmission is either permanently coupled to a crankshaft of the internal combustion engine in a rotationally fixed manner or is connectable thereto via an intermediate separating clutch or a starting component, wherein a torsional vibration damper is also providable between the internal combustion engine and the transmission. On the output end, the transmission is then preferably coupled, within the motor vehicle drive train, to an axle transmission of a drive axle of the motor vehicle, wherein a connection to an interaxle differential is also present in this case, however, via which a distribution to multiple driven axles of the motor vehicle takes place.

In the sense of the invention, the expression that two components of the transmission are “connected” or “coupled” to each other means that these components are permanently connected, and therefore these components rotate at one and the same rotational speed. In that respect, no shift element is provided between these components, which are elements of the planetary gear sets or even shafts or a rotationally fixed component of the transmission. Instead, the corresponding components are rigidly connected to each other.

On the other hand, if a shift element is provided between two components of the transmission, these components are not permanently coupled to each other in a rotationally fixed manner. Instead, a rotationally fixed coupling is first carried out via the intermediate shift element, and these components are “connectable” or “coupleable” to each other. In this case, an actuation of the shift element means, in the sense of the invention, that the respective shift element is transferred into an engaged condition and, consequently, equalizes the components coupled thereto in terms of their turning motions. In the case of an embodiment of the respective shift element as a form-fit shift element, the components rotationally fixed to each other via the shift element rotate at the same rotational speed, while, in the case of a friction-locking shift element, speed differences can exist between the components even after an actuation of said shift element. This intentional or even unintentional condition is nevertheless referred to, within the scope of the invention, as a rotationally fixed connection of the respective components via the shift element.

### BRIEF DESCRIPTION OF THE DRAWINGS

References in the claims to the drawings via the use of reference characters is not intended to limit the scope of protection of the claims.

Advantageous embodiments of the invention, which are explained in the following, are represented in the drawings. In the drawings, the following is shown:

FIG. 1 shows a schematic view of a motor vehicle drive train in which a transmission according to the invention is utilized;

FIG. 2 shows a schematic view of a transmission according to a first embodiment of the invention;

FIG. 3 shows a schematic of a transmission according to a second design option of the invention;

FIG. 4 shows a schematic view of a transmission according to a third embodiment of the invention;

FIG. 5 shows a schematic of a transmission according to a fourth design option of the invention; and

FIG. 6 shows an exemplary shift pattern of the transmission from FIGS. 2 to 5.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

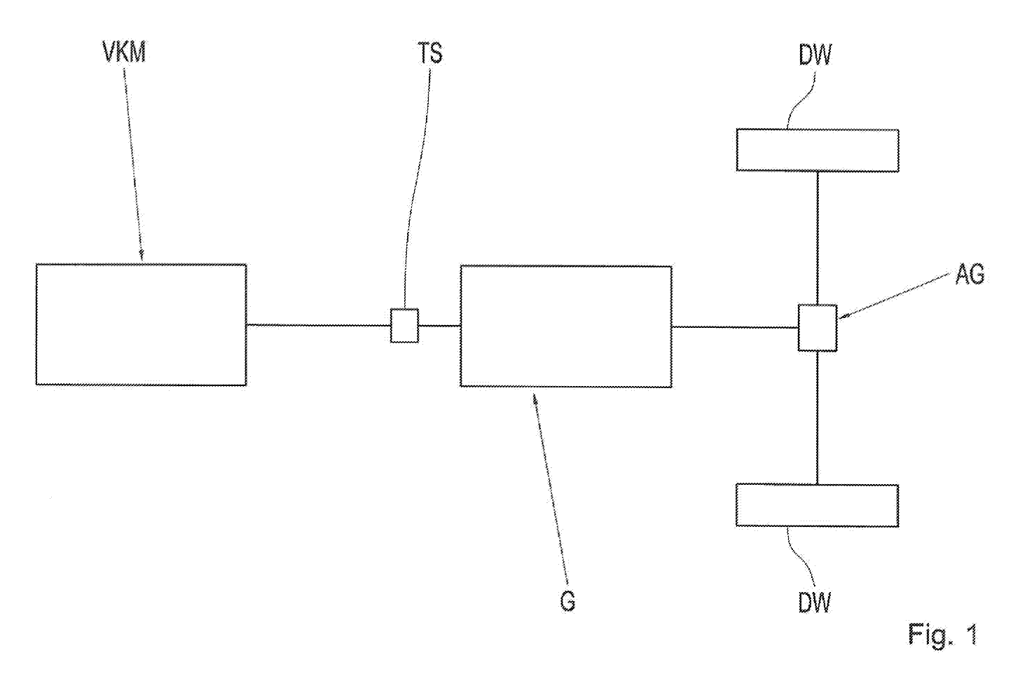

FIG. 1 shows a schematic view of a motor vehicle drive train, in which an internal combustion engine VKM is connected to a transmission G via an intermediate torsional vibration damper TS. Connected downstream from the transmission G, on the output end thereof, is an axle transmission AG, via which drive power is distributed to driving wheels DW on a drive axle of the motor vehicle.

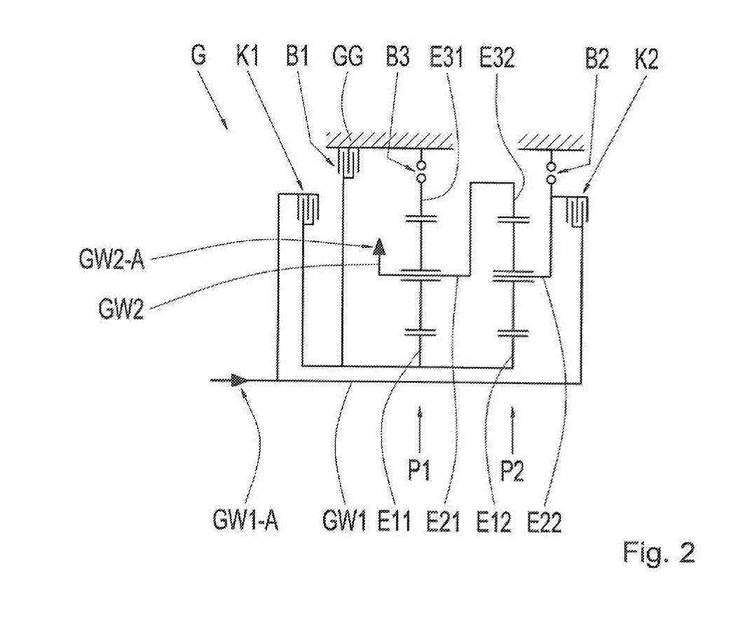

FIG. 2 shows a schematic of the transmission G according to a first embodiment of the invention. As is apparent, the transmission G includes a first planetary gear set P1 and a second planetary gear set P2. Each of the planetary gear sets P1, P2 includes a first element E11, E12, a second element E21, E22, and a third element E31, E32. The first element E11, E12 of each of the first and second planetary gear sets P1, P2 is always a sun gear, while the second element E21, E22 of each of the first and second planetary gear sets P1, P2 a planet carrier. The third element E31, E32 of each of the first and second planetary gear sets P1, P2 is a ring gear.

The planetary gear sets P1, P2 are therefore each configured as minus planetary gear sets, in which the respective planet carrier guides one planetary gear, although preferably multiple planetary gears, in a rotatably mounted manner, each of the planetary gears individually intermeshing with the radially internal sun gear and also with the surrounding ring gear. At a point which would be permissible by the connection, however, individual or even both of the first and second planetary gear sets P1, P2 could also be so-called plus planetary gear sets, in which a respective planet carrier supports at least one pair of planet gears, one planet gear of each pair of the at least one pair of planet gears being meshed with a radially internal sun gear and the other planet gear of each pair of the at least one pair of planet gears being meshed with a radially surrounding ring gear, and the planet gears in each pair of the at least one pair of planet gears intermesh with each other. As compared to a minus planetary gear set, the second element E21, E22 would then need to be a ring gear and the third element E31, E32 would need to be a planet carrier and, in addition, a stationary transmission ratio would need to be increased by one.

As is apparent in FIG. 2, the transmission G includes a total of five shift elements including a first shift element K1, a second shift element K2, a third shift element B1, a fourth shift element B2, and a fifth shift element B3. In this case, each of the first, second, and third shift elements K1, K2 and B1 is a friction-locking shift element and is preferably a lamellar shift element, while each of the fourth and fifth shift elements B2 and B3 is a form-fit shift element, such as constant-mesh shift elements or even lock-synchronizer mechanisms. The first shift element K1 and the second shift element K2 are each configured as a clutch in this case, while each of the third shift element B1, the fourth shift element B2, and the fifth shift element B3 is a brake.

An input shaft GW1 of the transmission G is connectable, on the one hand, via the first shift element K1 to the first element E11 of the first planetary gear set P1 which is rigidly connected to the first element E12 of the second planetary gear set P2. On the other hand, the input shaft GW1 is rotationally fixable via the second shift element K2 to the second element E22 of the second planetary gear set P2, the second element E22 of the second planetary gear set P2 being rotationally fixable to a rotationally fixed component GG of the transmission G via the fourth shift element B2. In this case, the rotationally fixed component GG is, in particular, a transmission housing or a part of a transmission housing.

Apart from the connection to the input shaft GW1, the first element E11 of the first planetary gear set P1 and the first element E12 of the second planetary gear set P2 are rotationally fixable to the rotationally fixed component GG via the third shift element B1. Moreover, the second element E21 of the first planetary gear set P1 and the third element E32 of the second planetary gear set P2 are rigidly connected to each other and are also jointly rotationally fixed to an output shaft GW2 of the transmission G. Finally, the third element E31 of the first planetary gear set P1 is rotationally fixable to the rotationally fixed component GG via the fifth shift element B3.

The two planetary gear sets P1 and P2 are axially arranged in the sequence first planetary gear set P1 and second planetary gear set P2, wherein the first shift element K1 and the third shift element B1 are located axially on a side of the first planetary gear set P1 facing away from the second planetary gear set P2, on which side a mounting interface GW1-A of the input shaft GW1 also lies. On the other hand, the second shift element K2 and the fourth shift element B2 are arranged on an axial end of the transmission G lying opposite thereto and, therefore, lie on a side of the second planetary gear set P2 facing away from the first planetary gear set P1. The fifth shift element B3 is located axially at the level of the first planetary gear set P1 and radially surrounds the first planetary gear set P1. Due to the spatial proximity, the first shift element K1 and the third shift element B1, as well as the second shift element K2 and the fourth shift element B2 could each be supplied by a shared line.

In addition, a mounting interface GW2-A of the output shaft GW2, which lies axially between the first planetary gear set P1 and the third shift element B1 in this case is coaxial to the mounting interface GW1-A of the input shaft GW1. The mounting interface GW1-A of the input shaft GW1 is utilized, in the motor vehicle drive train from FIG. 1, for connection to the internal combustion engine VKM, while the transmission G is connected to the subsequent axle transmission AG at the mounting interface GW2-A of the output shaft GW2. Preferably, the mounting interface GW2-A includes a tooth system in this case, which, in the installed condition of the transmission G, intermeshes with an associated tooth system of a shaft which is not represented. This shaft is then arranged axially parallel to the input shaft and the output shaft GW1 and GW2, respectively, wherein an axle transmission is then able to be arranged on this shaft. In that respect, the transmission G represented in FIG. 2 is suitable for the application in a motor vehicle drive train which is aligned transversely to the direction of travel of the motor vehicle.

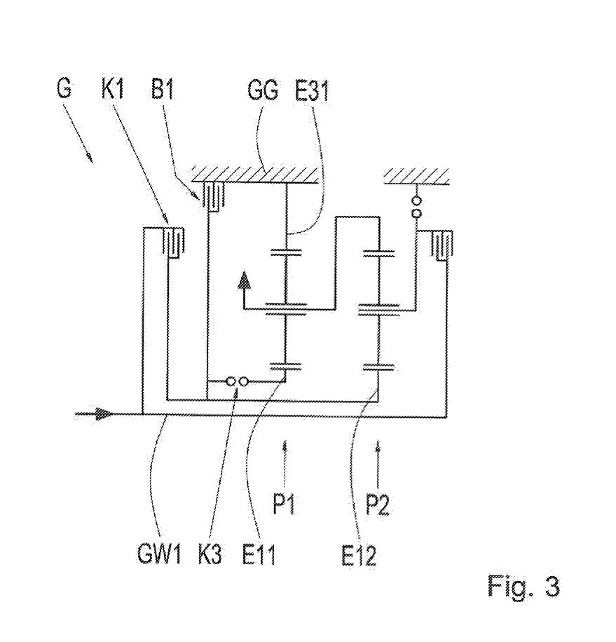

FIG. 3 shows a schematic view of a transmission G according to a second design option of the invention, which essentially corresponds to the variant represented in FIG. 2. In contrast to the variant according to FIG. 2, the third element E31 of the first planetary gear set P1 is rigidly connected to the rotationally fixed component GG, while the first element E11 of the first planetary gear set P1 is not permanently coupled in a rotationally fixed manner to the first element E12 of the second planetary gear set P2, but rather is rotationally fixable thereto via a fifth shift element K3. In this case, the fifth shift element K3 lies axially between the first planetary gear set P1 and the third shift element B1 and is a clutch. In this case, as is also the case with the variant according to FIG. 2, the first element E12 of the second planetary gear set P2 is connectable, on the one hand, to the input shaft GW1 via the first shift element K1 and, on the other hand, is rotationally fixable to the rotationally fixed component GG via the third shift element B1. For the rest, the embodiment according to FIG. 3 also corresponds to the variant according to FIG. 2, and therefore reference is made to the description thereof.

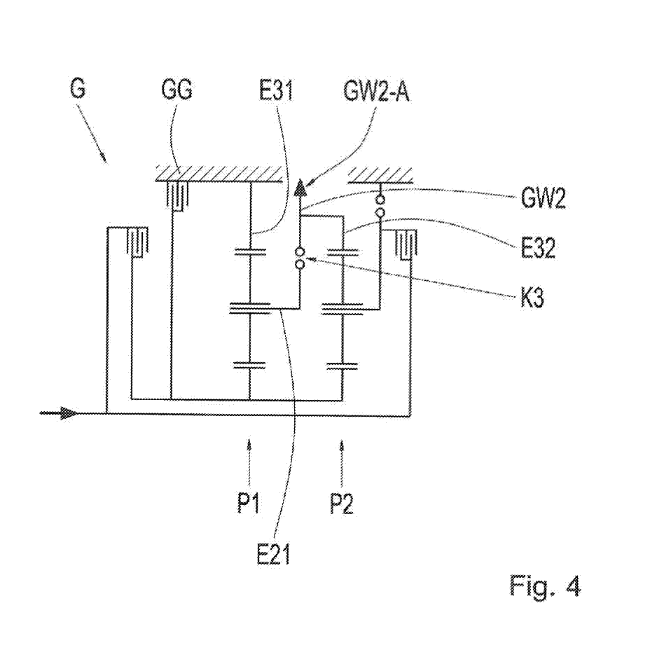

Moreover, FIG. 4 shows a schematic of a transmission according to a third embodiment of the invention, which also essentially corresponds to the variant according to FIG. 2. The difference in this case is that the third element E31 of the first planetary gear set P1 is permanently rotationally fixed to the rotationally fixed component GG, while the second element E21 of the first planetary gear set P1 is not permanently coupled in a rotationally fixed manner to the third element E32 of the second planetary gear set P2 and to the output shaft GW2, but rather is rotationally fixable thereto via a fifth shift element K3. The fifth shift element K3, which is a clutch, lies axially between the first planetary gear set P1 and the second planetary gear set P2 in this case, wherein the mounting interface GW2-A of the output shaft GW2 is also located in this area. The third element E32 of the second planetary gear set P2 and the output shaft GW2 are connected to each other in a rotationally fixed manner in this case as well. For the rest, the embodiment according to FIG. 4 corresponds to the variant according to FIG. 2, and therefore reference is made to the description thereof.

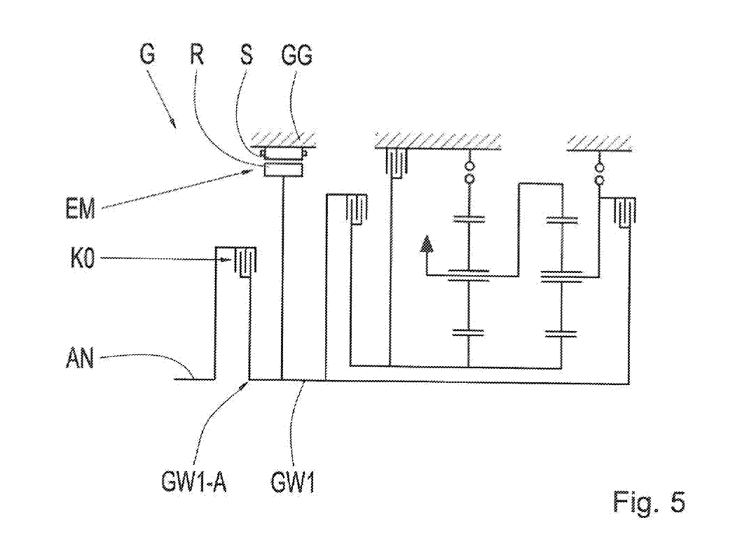

FIG. 5 shows a transmission G according to a fourth embodiment of the invention, which essentially corresponds to the variant from FIG. 2. The difference, however, is that an electric machine EM is additionally provided, a stator S of the electric machine EM being rotationally fixed to the rotationally fixed component GG, while a rotor R of the electric machine EM is rotationally fixed to the input shaft GW1. Moreover, the input shaft GW1 is rotationally fixable, at its mounting interface GW1-A, via an intermediate separating clutch K0, which is a lamellar shift element in this case, to a connecting shaft AN which, in turn, is connected to a crankshaft of the internal combustion engine VKM via the intermediate torsional vibration damper TS.

Purely electric driving is implementable via the electric machine EM, wherein, in this case, the separating clutch K0 is disengaged in order to decouple the input shaft GW1 from the connecting shaft AN and to not entrain the internal combustion engine VKM. For the rest, the embodiment according to FIG. 5 corresponds to the variant according to FIG. 2, and therefore reference is made to the description thereof.

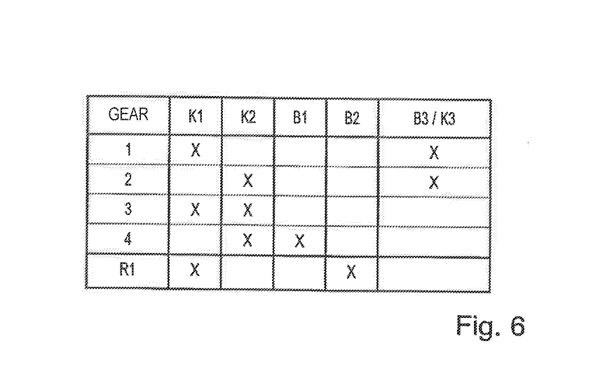

FIG. 6 shows an exemplary shift pattern for the respective transmission G from FIGS. 2 to 5 in table form. As is apparent, a total of four forward gears 1 to 4 and one reverse gear R1 are implementable in this case, wherein, in the columns of the shift pattern, an “X” indicates which of the first, second, third, fourth, and fifth shift elements K1, K2, B1, B2,B3 or K3 is engaged in which of the forward gears 1 to 4 and the reverse gear R1. In each of the forward gears 1 to 4 and the reverse gear R1, two of the first, second, third, fourth, and fifth shift elements K1, K2, B1, B2, B3 or K3 are engaged, wherein, when the forward gears 1 to 4 are shifted in succession, one of the contributing shift elements is to be disengaged and another shift element is to be subsequently engaged in each case.

As is apparent in FIG. 6, a first forward gear 1 is selected by actuating the first shift element K1 and the fifth shift element B3 or K3, wherein, originating from here, a second forward gear 2 is formed by disengaging the first shift element K1 and subsequently engaging the second shift element K2. It is then possible to shift into a third forward gear 3 by disengaging the fifth shift element B3, K3 and, in turn, engaging the first shift element K1. Proceeding therefrom, a fourth forward gear 4 is then obtained by disengaging the first shift element K1 and engaging the third shift element B1.

The reverse gear R1, in which a reverse operation of the motor vehicle is implementable even during driving with the aid of the internal combustion engine VKM, is selected, on the other hand, by engaging the first shift element K1 and the fourth shift element B2.

As represented in FIGS. 2 to 5, each of the fourth shift element B2 and the fifth shift element B3 or K3 is a form-fit shift element. Each of the fourth shift element B2 and the fifth shift element B3 or K3 is also implementable as a friction-locking shift element, such as a lamellar shift element.

The arrangement of an electric machine EM shown in FIG. 5 is also correspondingly applicable in the variants of FIGS. 2 to 4, by correspondingly rotationally fixing a rotor R of the electric machine to the input shaft GW1.

With the aid of the embodiments according to the invention, a transmission having a compact design and good efficiency is implementable.

Modifications and variations can be made to the embodiments illustrated or described herein without departing from the scope and spirit of the invention as set forth in the appended claims.

### REFERENCE CHARACTERS

G transmission
GG rotationally fixed component
P1 first planetary gear set
E11 first element of the first planetary gear set
E21 second element of the first planetary gear set
E31 third element of the first planetary gear set
P2 second planetary gear set
E12 first element of the second planetary gear set
E22 second element of the second planetary gear set
E32 third element of the second planetary gear set
K1 first shift element
K2 second shift element
B1 third shift element
B2 fourth shift element
B3 fifth shift element
K3 fifth shift element
1 first forward gear
2 second forward gear
3 third forward gear
4 fourth forward gear
R1 reverse gear
GW1 input shaft
GW1-A external interface of the input shaft
GW2 output shaft
GW2-A external interface of the output shaft
EM electric machine
S stator
R rotor
AN connecting shaft
K0 separating clutch
VKM internal combustion engine
TS torsional vibration damper
AG axle transmission
DW driving wheel

1-15. (canceled)

16. A transmission (G) for a motor vehicle, comprising:
an input shaft (GW1);
an output shaft (GW2);
a first planetary gear set (P1) having a first element (E11), a second element (E21), and a third element (E31), and a second planetary gear set (P2) having a first element (E12), a second element (E22), and a third element (E32), the first and second planetary gear sets (P1, P2) guiding a power flow from the input shaft (GW1) to the output shaft (GW2); and
a first shift element (K1), a second shift element (K2), a third shift element (B1), a fourth shift element (B2), and a fifth shift element (B3 or K3),
wherein selective actuation of the first, second, third, fourth, and fifth shift elements (K1, K2, B1, B2, B3; K3) couples the first and second planetary gear sets (P1, P2) to each other while selecting different gear ratios (1 to 4, R1) between the input shaft (GW1) and the output shaft (GW2),
wherein the input shaft (GW1) is rotationally fixable to the first element (E12) of the second planetary gear set (P2) via the first shift element (K1), and the input shaft (GW1) is rotationally fixable to the second element (E22) of the second planetary gear set (P2) via the second shift element (K2),
wherein the first element (E12) of the second planetary gear set (P2) is rotationally fixable to a rotationally fixed component (GG) via the third shift element (B1), and the second element (E22) of the second planetary gear set (P2) is rotationally fixable to the rotationally fixed component (GG) via the fourth shift element (B2), and
wherein the third element (E32) of the second planetary gear set (P2) is rotationally fixed to the output shaft (GW2).

17. The transmission (G) of claim 16, wherein:
the first element (E11) of the first planetary gear set (P1) is rotationally fixed to the first element (E12) of the second planetary gear set (P2);
the third element (E32) of the second planetary gear set (P2) is rotationally fixed to the second element (E21) of the first planetary gear set (P1); and
the third element (E31) of the first planetary gear set (P1) is rotationally fixable to the rotationally fixed component (GG) via the fifth shift element (B3).

18. The transmission (G) of claim 16, wherein:
the third element (E31) of the first planetary gear set (P1) is permanently rotationally fixed to the rotationally fixed component (GG);
the second element (E21) of the first planetary gear set (P1) is rotationally fixed to the third element (E32) of the second planetary gear set (P2); and
the first element (E11) of the first planetary gear set (P1) is rotationally fixable to the first element (E12) of the second planetary gear set (P2) via the fifth shift element (K3).

19. The transmission (G) of claim 16, wherein:
the third element (E31) of the first planetary gear set (P1) is permanently rotationally fixed to the rotationally fixed component (GG);
the first element (E11) of the first planetary gear set (P1) is rotationally fixed to the first element (E12) of the second planetary gear set (P2); and
the second element (E21) of the first planetary gear set (P1) is rotationally fixable to the third element (E32) of the second planetary gear set (P2) via the fifth shift element (K3).

20. The transmission (G) of claim 17, wherein:
a first forward gear (1) is selectable by actuating the first shift element (K1) and the fifth shift element (B3; K3);
a second forward gear (2) is selectable by actuating the second shift element (K2) and the fifth shift element (B3; K3);
a third forward gear (3) is selectable by actuating the first shift element (K1) and the second shift element (K2);
a fourth forward gear (4) is selectable by actuating the second shift element (K2) and the third shift element (B1); and
a reverse gear (R1) is selectable by actuating the first shift element (K1) and the fourth shift element (B2).

21. The transmission (G) of claim 16, wherein one or more of the first and second planetary gear sets (P1, P2) is a minus planetary gear set, the first element (E11, E12) of the minus planetary gear set is a sun gear, the second element (E21, E22) of the minus planetary gear set is a planet carrier, and the third element (E31, E32) of the minus planetary gear set is a ring gear.

22. The transmission (G) of claim 16, wherein one or more of the first and second planetary gear sets (P1, P2) is a plus planetary gear set, the first element (E11, E12) of the plus planetary gear set is a sun gear, the second element (E21, E22) of the plus planetary gear set is a ring gear, and the third element (E31, E32) of the plus planetary gear set is a planet carrier.

23. The transmission (G) of claim 16, wherein one or more of the first, second, and third shift elements (K1, K2, B1) is a friction-locking shift element.

24. The transmission (G) of claim 16, wherein one or more of the fourth shift element (B2) and the fifth shift element (B3; K3) is a form-fit shift element.

25. The transmission (G) of claim 16, wherein one or more of the first shift element (K1) and the third shift element (B1) is arranged on a side of the first planetary gear set (P1) facing a mounting interface (GW1-A) of the input shaft (GW1).

26. The transmission (G) of claim 16, wherein one or more of the second shift element (K2) and the fourth shift element (B2) is arranged on a side of the second planetary gear set (P2) facing away from a mounting interface (GW1-A) of the input shaft (GW1).

27. The transmission (G) of claim 16, wherein mounting interfaces (GW1-A, GW2-A) of the input shaft (GW1) and of the output shaft (GW2) are coaxial.

28. The transmission (G) of claim 16, further comprising an electric machine (EM), a rotor (R) of the electric machine (EM) rotationally fixed to one of the rotatable components of the transmission or to the input shaft (GW1).

29. The transmission (G) of claim 16, further comprising a separating clutch (K0), the input shaft (GW1) being rotationally fixable to a connecting shaft (AN) via the separating clutch (K0).

30. A motor vehicle drive train comprising the transmission (G) of claim 16.
